(19) United States
(12) Patent Application Publication
(10) Pub. No.: US 2008/0055573 A1
(43) Pub. Date: Mar. 6, 2008

(54) PROJECTOR WITH BUILD-IN IPOD INSERTION SLOT

(76) Inventor: James Chu, Walnut, CA (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/468,837

(22) Filed: Aug. 31, 2006

(51) Int. Cl. G03B 21/00

(52) U.S. Cl. 353/122

(57) ABSTRACT

The present new model is to reveal a kind of projector, and in particular a kind of projector with build-in iPod insertion slot including a projector main body, the said projector main body is installed an insertion slot, through the insertion slot an iPod electronic device can be plugged into the insertion slot; a metal connecting port installed at the base of the insertion slot and for the connection to a control processor, the control processor is installed inside the projector main body, responsible for the control and operation of signal input and output of the projector main body, and through the control processor the iPod electronic device in connection can be controlled and read out indirectly. Such projector combined with insertion slot saves the complicated external connection setup, saves space effectively, and projectors can be designed with better and more practical shape for iPod products.

### FIELD OF THE INVENTION

The present new model relates to a kind of projector, and more particularly to a kind of projector with a build-in iPod insertion slot.

### BACKGROUND OF THE INVENTION

For the conventional art, please refer to the diagram shown in FIG. 1. The diagram shown in Figure is an ordinary projector 10. The said ordinary projector 10 is installed with an AV female connector 12 to the AV signals input from outside devices through projector 10. When it is intended to display the iPod's video content popular in the market through the projector 10, an additional iPod insertion slot 16 is required to purchase. The said iPod insertion slot 16 has two transmission lines, one of these lines is signal output line 18 with an AV male connector 20 to be connected to the AV female connector 12 on the projector 10 and is responsible for outputting the AV data stored inside the iPod 14 to the projector 10 for projection display while the other line has a USB connector 22 that is responsible for connecting signals to the computer and for charging of electricity so that the computer could perform the storing action to the iPod 14. However, there are some drawbacks in the conventional art as shown below:
1. When the iPod external insertion slot 16 is missing, the iPod 14 becomes a waste. The data stored inside the iPod 14 cannot be passed on to the projector and is a serious drawback.
2. Any modern electronic product with simplified operation does not allow a messy wiring for connecting to the outside world. It is not only ugly but greatly lower the practicality and convenience.
3. Another aspect is that it must go through external USB connector 22 in order to charge up iPod 14, which is not convenient.

In view of these, the present new model proposes a kind of projector with iPod insertion slot in order to resolve the drawbacks of the conventional art.

### SUMMARY OF THE INVENTION

A primary object of the present invention is to provide a projector with a build-in iPod insertion slot; through the insertion slot of the projector, the iPod electronic device is plugged onto the insertion slot. In this way, it is possible to operate the iPod electronic device directly from the projector main body to read the data, and project and playback the video and/or audio files inside the iPod electronic device. The external connection slot will not be needed and the space can be effectively saved to make the projector more easy and convenient to use.

To achieve the above prescribed object, the present new model reveals a kind of projector, and particularly a kind of projector with build-in iPod insertion slot, including a projector main body, the said projector main body is installed an insertion slot, through the slot an iPod electronic device can be plugged into the insertion slot; a metal connecting port is installed at the base of the insertion slot and for the connection to a controlling processor, and the controlling processor is installed inside projector, responsible for the controlling and operation of input and output of the projector main body's signal, and indirectly controls the reading of iPod electronic device through the processor. The kind of projector combined with insertion slot saves the complicated external connections and saves the space effectively and it is possible to design projectors with better and more practical shape for iPod products.

### BRIEF DESCRIPTION OF THE DRAWINGS

FIG. 1 is the conventional art.

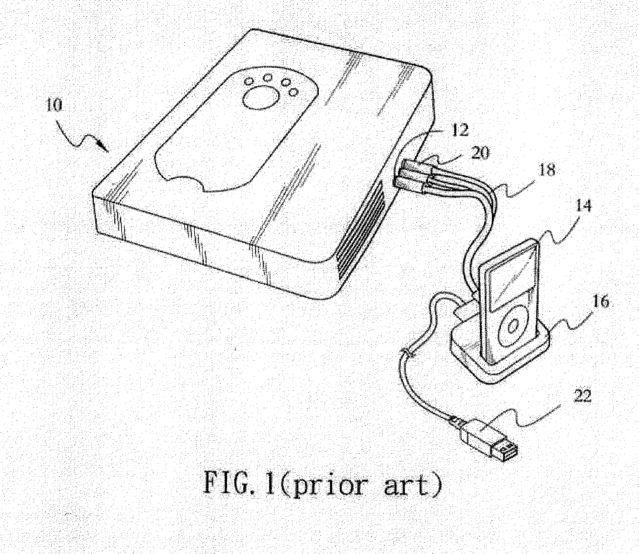

FIG. 2 is the 3D diagram of the projector with iPod insertion slot of the present new model.

FIG. 3 is the block diagram of the projector with iPod insertion slot of the present new model.

### DETAILED DESCRIPTION OF THE PREFERRED EMBODIMENTS

For the ease and clarity in understanding other features and merits of the present new model and for the manifestation of the performance achieved, the present invention is further described below together with illustrations:

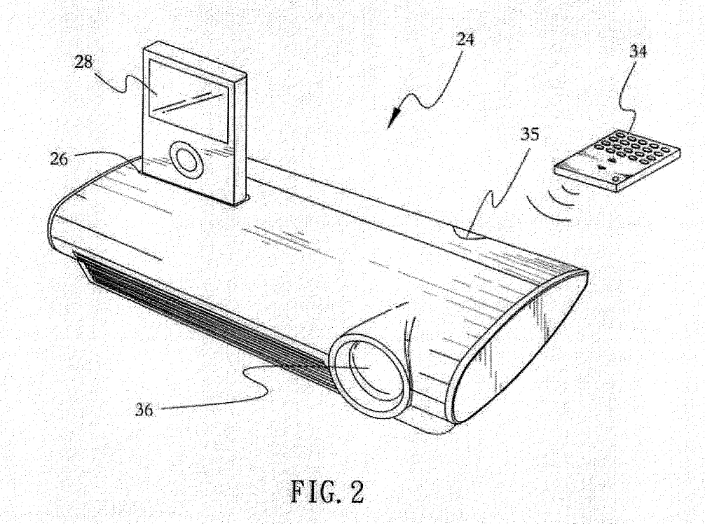

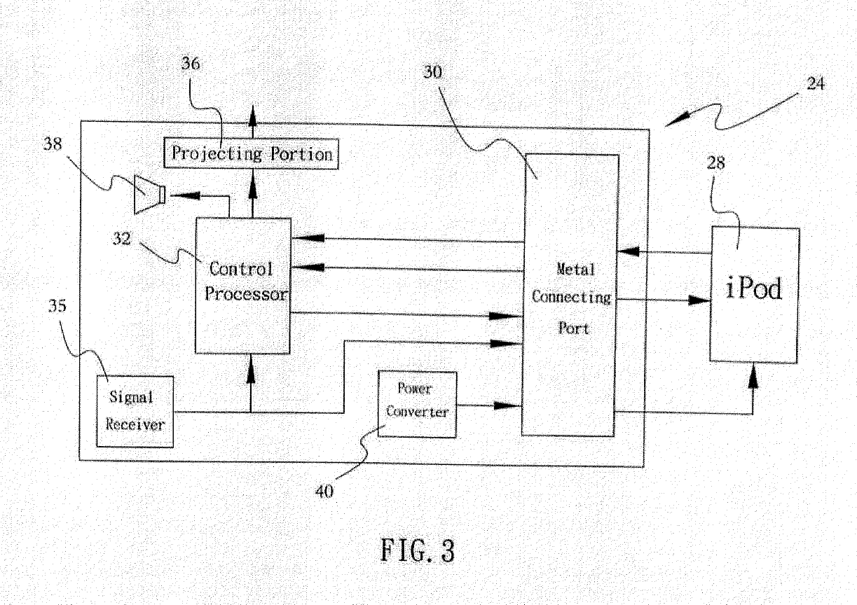

Please refer to FIG. 2, which illustrates the 3D diagram of the projector with build-in iPod insertion slot of the present new model, and FIG. 3, which illustrates the block diagram of the projector with iPod insertion slot of the present new model. As shown, a projector main body 24, the surface of the said projector main body 24 is installed with an insertion slot 26, the said insertion slot 26 can fit the iPod electronic device 28 currently available in the market, and at the base of the insertion slot 26 is connected to a metal connecting port 30, responsible for connecting to the control processor 32 inside the said projector main body 24; the said control processor 32 is responsible for the control and operation of the signal input and output of the projector main body 24, and through the said control processor 32 it is also possible to read and control the iPod electronic device 28 in connection, and inside the said projector main body 24 a signal receiver 35 is installed, for remote control of the operation of the said control processor 32. As such, when the iPod electronic device 28 is inserted into the insertions lot 26 on the projector main body 24, it is possible to select the AV files in the iPod electronic device 28 through a remote control 34 indirectly and projected and playback from a projecting portion 36 inside the projector main body 24; another speaker 38 and signal receiver 35 is installed on the projector main body 24, connected to the control processor 32 respectively, for the control of the output of sound effect and functional menu to perform repetitive playback or playback action of a particular file. In addition, the projector main body 24 further includes a power converter 40 connecting to the metal connecting port 30, that is possible to provide iPod electronic device 28 with power or perform charging action to the iPod electronic device 28, saving the trouble of connecting another power cable, and further the size of the insertion slot 26 can be replaced according to the size of the iPod electronic device 28 to fit all kinds of iPod electronic device 28.

The present new model is to reveal a kind of projector, and particularly a kind of projector built with iPod insertion slot, including a projector main body, the said projector main body is installed with an insertion slot, through the insertion slot an iPod electronic device and be fitted into the insertion slot; a metal connecting port installed in the base of the insertion slot for the connection to a control processor, the said control processor is installed inside the projector main body responsible for the control of the signal input and output of the projector main body, and through the control processor it is possible to control and read the iPod electronic device indirectly. Such projector combining insertion slot saves the complicated external connecting device, saves the space effectively, and the shape of the projector can be better and practical depending on the design of iPod product.

In summary, the present new model with breakthrough in the prior structural technology has already achieved the intended performance, and is indeed not easy for people familiar with the art to think of. In addition, this invention has not been published before and its advances and practicality has met the requirement for the application of patent. In view of this, the inventor is filing this invention according to the law. It is hopeful that your committee will grant the patent for this invention for encouragement of innovation.

The embodiment described above is for the explanation of the features of the technology and thinking of the present new model. The purpose is for the understanding of content of the present new model for people familiar with the art and should not be regarded as the limited range of the present new model. All equivalent variations or modifications based on the spirit revealed by this new model shall be covered in the range of the patent of the present new model.

What is claimed is:

1. A projector build-in with iPod insertion slot, including a projector main body, the said projector main body is installed with an insertion slot, through the said insertion slot an iPod electronic device can be plugged into the said insertion slot;
A metal connection port, installed at the base of the said insertion slot; and
A control processor for the connection to the said connection port, installed inside the said projector main body, responsible for the control and operation of signal input and output of the said projector main body and through the said control processor it is possible to read the said iPod electronic device in connection.

2. As the projector with build-in iPod insertion slot described in the claim 1 of this patent, the said projector main body further includes a power converter, connecting to the said metal connecting port, for providing the said iPod electronic device with power.

3. As the projector with build-in iPod insertion slot described in the claim 2 of this patent, where he said power converter also can be used to charge the said iPod electronic device.

4. As the projector with build-in iPod insertion slot described in the claim 1 of this patent, where the said control processor is connected to a speaker and installed inside the said projector main body, for the playback of the files in the said iPod electronic device.

5. As the projector with build-in iPod insertion slot described in the claim 1 of this patent, the said projector main body is installed with an additional remote control, and inside the said projector main body is installed with a corresponding signal receiver, for the remote control of the said processor.

6. As the projector with build-in iPod insertion slot described in the claim 1 of this patent, where the size of the insertion slot can be replaced according to the size of the iPod electronic device.
